(19) United States
(12) Patent Application Publication
(10) Pub. No.: US 2016/0210839 A1
(43) Pub. Date: Jul. 21, 2016

(54) MULTIMODAL MONITORING SYSTEMS FOR PHYSICAL ACTIVITY

(71) Applicant: XEROX CORPORATION, Norwalk, CT (US)

(72) Inventors: Kuldeep Yadav, Gurgaon (IN); Vaibhav Rajan, Bangalore (IN); Abhishek Kumar, New Delhi (IN); Nischal Murthy Piratla, Fremont, CA (US)

(21) Appl. No.: 14/597,303

(22) Filed: Jan. 15, 2015

(51) Int. Cl. G08B 21/04; H04W 4/00; H04N 7/18

(52) U.S. Cl. CPC G08B 21/0492; H04N 7/183; H04W 4/006; G08B 21/0461

(57) ABSTRACT

Embodiments of a computer-implemented method for monitoring a physical activity of a user are disclosed. The method includes receiving position or orientation data of a portable computing device; receiving an indication of an input device being operated by the user and a video captured by an imaging unit, the input device, and the imaging unit being operationally coupled to a stationary computing device. The portable computing device, the input device and the imaging unit are triggered by a data aggregator module based on a predefined sequence. The method also includes determining an activity pattern data of the user over a predefined time interval based on the position or orientation data, the received indication, and the video including an image of the user; and correlating the determined activity pattern data with health data of the user to monitor the physical activity of the user.

### TECHNICAL FIELD

The presently disclosed embodiments relate to monitoring systems for physical activity, and more particularly to multimodal monitoring systems for physical activity.

### BACKGROUND

With the evolution of computers, the number of desk jobs has increased phenomenally in the last few decades worldwide. Such desk jobs involve prolonged sitting that leads to moderate-to-low levels of physical activity. As a result, health problems such as diabetes, heart attack, and stroke have increased the mortality rate. For example, moderate-to-high amounts of sitting time (i.e., four hours or more) has been reported to cause significantly lower cardio-metabolic risks in adults as compared to those undergoing relatively lower amount of sitting time (i.e., less than three hours). Also, excessive sitting results in lower life expectancies and slower metabolism, thereby increasing the harmful effects of prolong sitting over a life time.

Various research works have indicated that physical activity and sitting are mutually distinct behaviors and that regular exercise does not necessarily negate the adverse effects of excessive sitting. Therefore, regular activity breaks from sitting is one of the recommended remedies toward better health, since the production of enzymes which burn fat declines by as much as 90% after one hour of sitting interval.

Existing products such as Jawbone Up™ and Nike Fuel Band™ alert users for excessive sitting. However, most of these products are costly wearable devices. Similarly, there are a few Android and iOS applications such as MotionX 24×7™ that use accelerometer sensors to track a person's activity. However, such mobile-based applications have limited coverage because many users tend to put their mobile phones on desks in workplace environments, thereby preventing the applications from collecting the required activity data to determine current posture. Also, these applications continuously sample accelerometer values of the mobile phone resulting in high energy consumption of the phone's battery. Hence, there is a need for ubiquitous, energy-efficient, as well as effective systems to track a user's activity in workplaces and provide personalized notifications to the user.

### SUMMARY

One embodiment of the present disclosure includes a computer-implemented method for monitoring a physical activity of a user. The method includes receiving, using a data aggregator module on a processor of a computer, position or orientation data of a portable computing device; receiving, using the data aggregator module, an indication of at least one input device being operated by the user and a video captured by an imaging unit, the at least one input device and the imaging unit being operationally coupled to a stationary computing device, wherein the portable computing device, the at least one input device and the imaging unit are triggered by the data aggregator module based on a predefined sequence; determining, using an activity recognition engine on the processor, an activity pattern data of the user over a predefined time interval based on the position or orientation data, the received indication, and the video including an image of the user; and correlating, using the activity recognition engine, the determined activity pattern data with health data of the user to monitor the physical activity of the user.

Another embodiment of the present disclosure includes a system for monitoring a physical activity of a user. The system includes a portable computing device a stationary computing device, and an activity aggregator engine. The portable computing device including at least one sensor configured to determine a position or an orientation data of the portable computing device. The stationary computing device including at least one input device and operationally coupled to an imaging unit. The stationary computing device may be configured to determine a position or an orientation of the portable computing device in communication with the at least one sensor; receive an indication of the at least one input device being operated by a user; and capture a video including one or more images using the imaging unit. The activity aggregator engine may be in communication with the stationary computing device and the portable computing device. The activity aggregator engine may be configured to determine an activity pattern data of the user over a predefined duration based on the determined position or orientation, received indication, and the captured video indicating the user; and correlate the determined activity pattern with health data of the user to monitor the physical activity of the user.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

FIG. 1A illustrates a first schematic including an exemplary activity aggregator engine implemented with a stationary computing device being operated by a user in a sedentary position, according to an embodiment of the present disclosure.

FIG. 1B illustrates a second schematic including the activity aggregator engine of FIG. 1 implemented with the stationary computing device being operated by the user in a non-sedentary position, according to an embodiment of the present disclosure.

FIGS. 2A-2D are schematics that illustrate exemplary network environments including the activity aggregator engine of FIG. 1, according to an embodiment of the present disclosure.

FIG. 3 illustrates the exemplary activity aggregator engine of FIG. 1, according to an embodiment of the present disclosure.

FIG. 4 illustrate an exemplary timing diagram for control signals generated by the activity aggregator engine of FIG. 1, according to an embodiment of the present disclosure.

FIG. 5 illustrates an exemplary method for implementing the activity aggregator engine of FIG. 1, according to an embodiment of the present disclosure.

### DETAILED DESCRIPTION

The following detailed description is made with reference to the figures. Some of the embodiments are described to illustrate the disclosure, not to limit its scope, which is defined by the claims. Those of ordinary skill in the art will recognize a number of equivalent variations in the description that follows.

### Exemplary Embodiments

Various embodiments describe systems and methods for ubiquitous and multimodal physical activity monitoring and notifications in a workplace environment. The embodiments include multiple input devices such as a webcam, a keyboard, and a mouse being used in combination with mobile phone sensors such as accelerometer and global positioning system (GPS) sensors to accurately track physical activity of a user. The methods and systems of the embodiments employ a technique based on triggered-sensing to activate or deactivate these sensors to minimize redundant observations and thus, minimizing energy consumption of battery-constrained mobile phones. The embodiments may also record a historical activity pattern of a user with personalized notifications for every user to suggest a predefined amount or duration of physical activity. Further, the embodiments may be configured to build personalized health risk profiles for various lifestyle diseases based on such user activity patterns, user personal or medical data, or various predefined disease profiles. The embodiments may generate activity recommendations based on the built personalized risk models to the user.

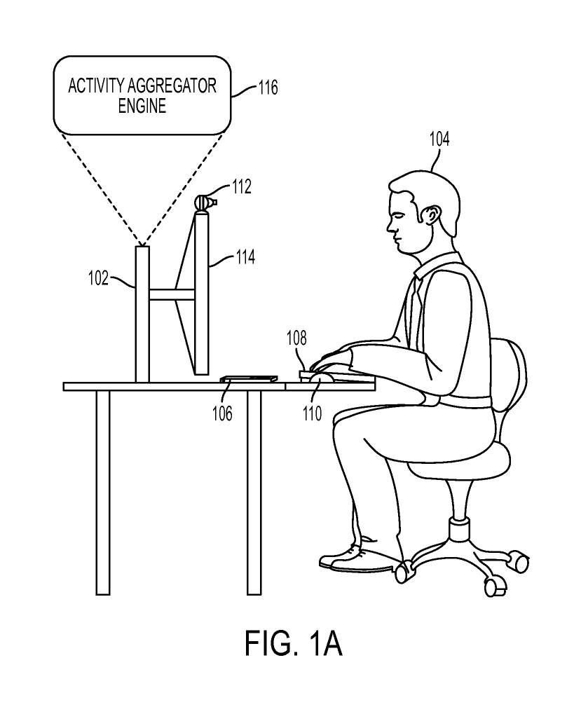

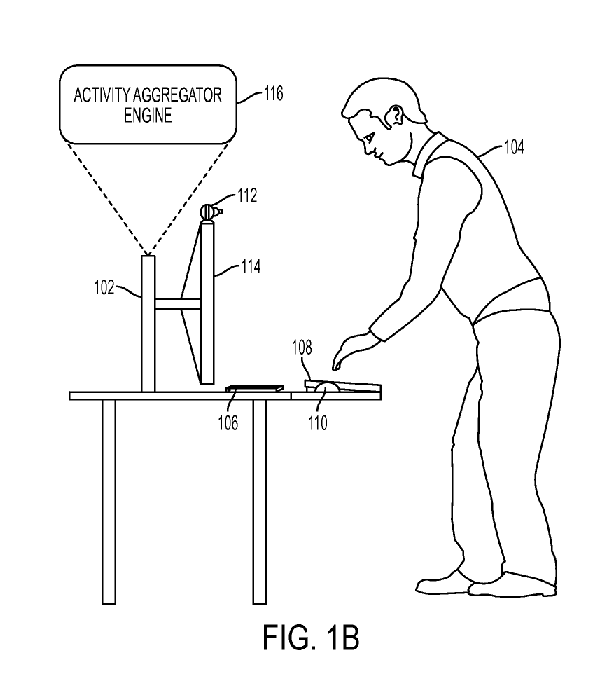

Some embodiments (FIGS. 1A and 1B) are disclosed in the context of a workplace environment that involve a stationary computing device 102 being operated by a user 104 in different body postures. However, other embodiments may be applied in the context of other business, personal, or social scenarios involving user interactions with the stationary computing device 102 in communication with a portable computing device. Examples of such scenarios may include, but are not limited to, bank agents handling customer account workflows or similar processes, healthcare professionals handling patient records in a tele-health environment, online retail agents handling customer requests and queries, teachers or students handling e-coursework, users engaged in playing games or browsing of social media websites such as Twitter™, Facebook™, etc.

The stationary computing device 102 such as a desktop personal computer (PC), a workstation, and a notebook may be coupled to various input and output devices. For example, the stationary computing device 102 may be associated with a display screen 114, a keyboard 108, a mouse 110, and a webcam 112. Other suitable input devices may include, but not limited to, digital pens, radiofrequency identification (RFID) readers, infrared scanners, biometric scanners, and optical emitter-detector pairs, being associated with the stationary computing device 102 either directly or indirectly via other computing devices (not shown). The stationary computing device 102 may communicate with a variety of portable computing devices known in the art, related art, or developed later. For example, the stationary computing device 102 may communicate with a mobile phone 106.

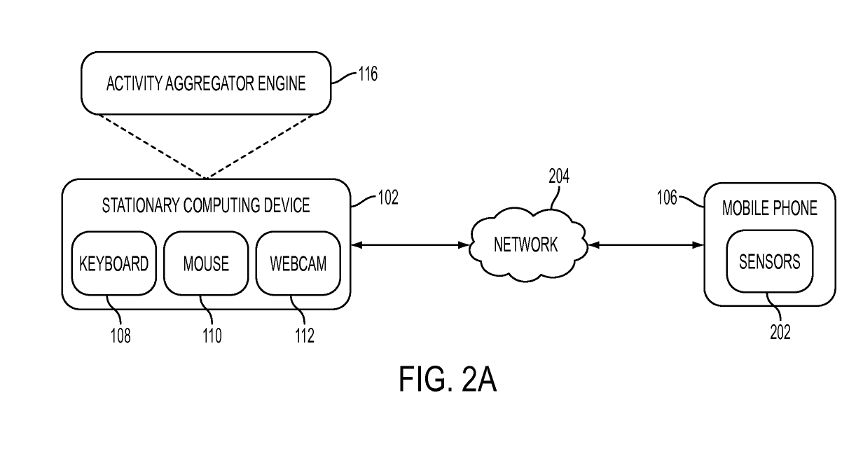

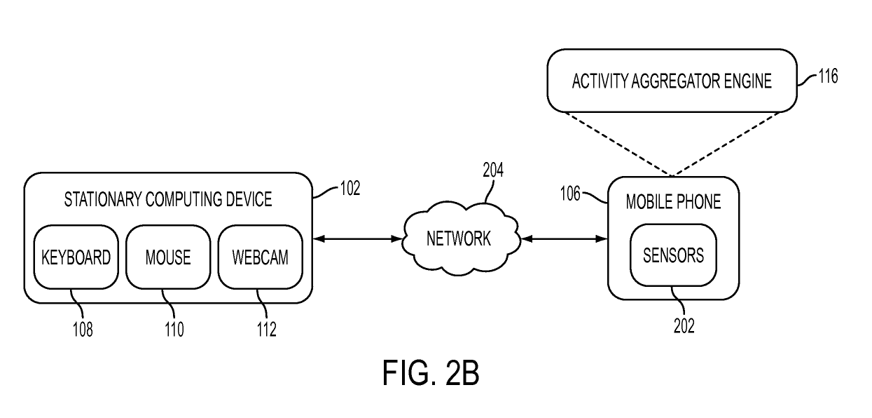

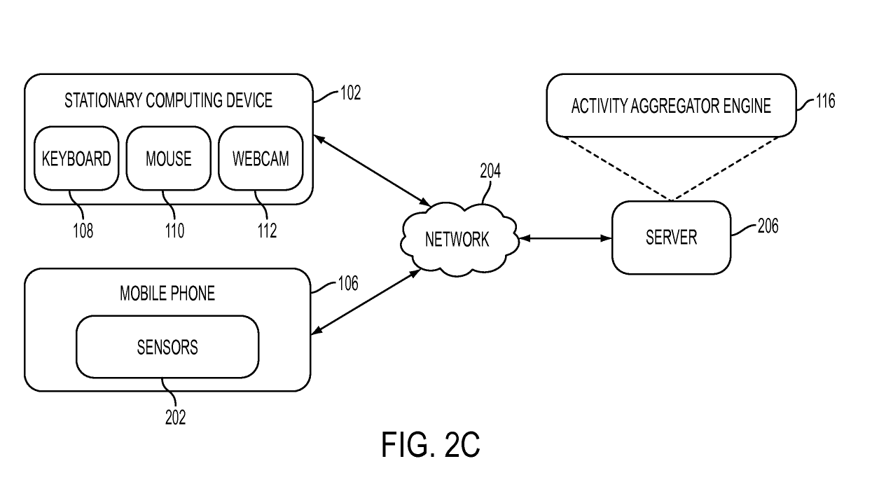

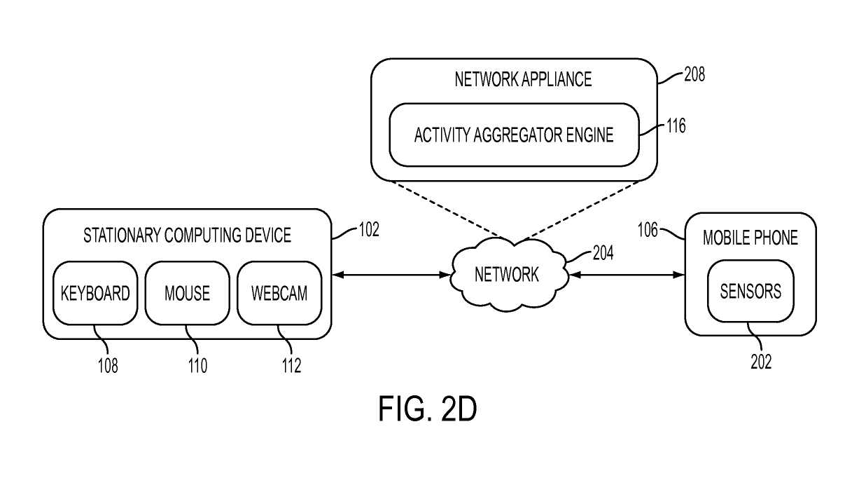

In one embodiment, the stationary computing device 102 may be installed, integrated, or operate in communication with an activity aggregator engine 116 configured to determine whether the stationary computing device 102 is being operated by the user 104 in a sedentary position such as a sitting position (FIG. 1A) or a non-sedentary position such as a standing position (FIG. 1B). For this, the portable computing device such as the mobile phone 106 may include one or more sensors 202 (FIGS. 2A-2D) configured to determine a location or an orientation of the mobile phone 106. Examples of the sensors 202 may include an accelerometer, a GPS sensor, or any combination of a variety of sensors known in the art, related art, or developed later. As shown in FIG. 2A, these sensors 202 in association with the input devices such as the keyboard 108, the mouse 110, and the webcam 112 may communicate with the activity aggregator engine 116 over a network 204. The network 204 may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network 204 may include multiple networks or sub-networks, each of which may include, for example, a wired or wireless data pathway. The network 204 may include a circuit-switched voice network, a packet-switched data network, or any other network able to carry electronic communications. For example, the network 204 may include networks based on the Internet protocol (IP) or asynchronous transfer mode (ATM), and may support voice using, for example, VoIP, Voice-over-ATM, or other comparable protocols used for voice, video, and data communications.

The activity aggregator engine 116 may be configured to at least one of: (1) communicate synchronously or asynchronously with one or more software applications, databases, storage devices, or appliances operating via same or different communication protocols, formats, database schemas, platforms or any combination thereof, to receive data; (2) collect, record, analyze, filter, index, and manipulate data including keystroke or mouse click detection data, visual detection data for the user 104, and sensor data from the portable computing device; (3) employ triggered sensing to dynamically control the sensors such as the sensors 202 of the portable computing device; (4) transfer, receive, or map data for communication with one or more networked computing devices and data repositories; (5) formulate one or more tasks such as those corresponding to an activity pattern of the user 104 for being learned from the data or datasets; (6) provide, execute, communicate, formulate, and train one or more mathematical models for the tasks for determining weighted health risk factors or health risk scores for the user 104; (7) generate customizable visual representations of the data or datasets; and (8) generate indications for the user 104 based on his activity pattern.

The activity aggregator engine 116 may represent any of a wide variety of devices capable of providing user activity recognition and related feedback services for the network devices. The activity aggregator engine 116 may be implemented as a standalone and dedicated device including hardware and installed software, where the hardware is closely matched to the requirements and/or functionality of the software. Alternatively, the activity aggregator engine 116 may be implemented as a software application or a device driver. The activity aggregator engine 116 may enhance or increase the functionality and/or capacity of the network, such as the network 204, to which it may be connected. In some other embodiments, the activity aggregator engine 116 may be configured to expose its computing environment or operating code to the user 104. The activity aggregator engine 116 of some embodiments may, however, include software, firmware, or other resources that support remote administration and/or maintenance of the activity aggregator engine 116.

In further embodiments, the activity aggregator engine 116 either in communication with any of the networked devices such as the mobile phone 106, or independently, may have video, voice, and data communication capabilities (e.g., unified communication capabilities) by being coupled to or including, additional imaging devices (e.g., printers, scanners, medical imaging systems, etc.), various audio devices (e.g., microphones, music players, recorders, audio input devices, speakers, audio output devices, telephones, speaker telephones, etc.), various video devices (e.g., monitors, projectors, displays, televisions, video output devices, video input devices, camcorders, etc.), or any other type of hardware, in any combination thereof. In some embodiments, the activity aggregator engine 116 may comprise or implement one or more real time protocols (e.g., session initiation protocol (SIP), H.261, H.263, H.264, H.323, etc.) and non-real time protocols known in the art, related art, or developed later to facilitate data transfer among the stationary computing device 102, the mobile phone 106, and any other network device.

In some embodiments, the activity aggregator engine 116 may be configured to convert communications, which may include instructions, queries, data, etc., from the mobile phone 106 into appropriate formats to make these communications compatible with the stationary computing device 102, and vice versa. Consequently, the activity aggregator engine 116 may allow implementation of the stationary computing device 102 using different technologies or by different organizations, e.g., a third-party vendor, managing the stationary computing device 102 or associated services using a proprietary technology.

In another embodiment (FIG. 2B), the activity aggregator engine 116 may be installed or integrated with the portable computing device such as the mobile phone 106. The activity aggregator engine 116 may be configured to interface between the mobile phone 106 and the stationary computing device 102, which may be associated with the input devices such as the keyboard 108, the mouse 110, and the webcam 112.

In further embodiments (FIG. 2C), the stationary computing device 102 may be configured to interact with the mobile phone 106 via a server 206 over the network 204. The server 206 may be installed, integrated, or operatively associated with the activity aggregator engine 116. The server 206 may be implemented as any of a variety of computing devices including, for example, a general purpose computing device, multiple networked servers (arranged in clusters or as a server farm), a mainframe, or so forth.

In some embodiments (FIG. 2D), the activity aggregator engine 116 may be installed on or integrated with any network appliance 208 configured to establish the network 204 between the stationary computing device 102 and the mobile phone 106. At least one of the activity aggregator engine 116 and the network appliance 208 may be capable of operating as or providing an interface to assist exchange of software instructions and data among the stationary computing device 102, the mobile phone 106, and the activity aggregator engine 116. In some embodiments, the network appliance 208 may be preconfigured or dynamically configured to include the activity aggregator engine 116 integrated with other devices. For example, the activity aggregator engine 116 may be integrated with the stationary computing device 102 (as shown in FIG. 2A), the mobile phone 106 (as shown in FIG. 2B), the server 206 (as shown in FIG. 2C) or any other user device (not shown) connected to the network 204. The stationary computing device 102 may include a module (not shown), which may enable the mobile phone 106 or the server 206 for being introduced to the network appliance 208, thereby enabling the network appliance 208 to invoke the activity aggregator engine 116 as a service. Examples of the network appliance 208 include, but are not limited to, a DSL modem, a wireless access point, a router, a base station, and a gateway having a predetermined computing power sufficient for implementing the activity aggregator engine 116.

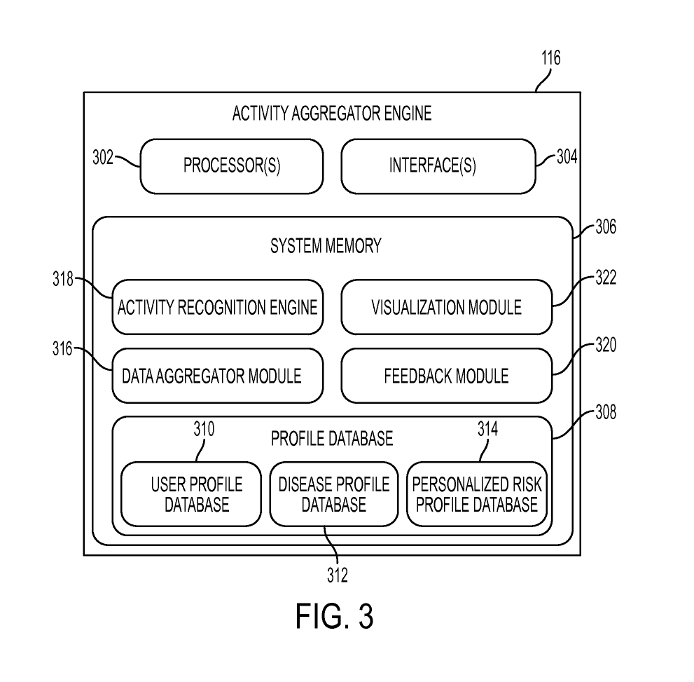

As illustrated in FIG. 3, the activity aggregator engine 116 may be implemented by way of a single device (e.g., a computing device, a processor or an electronic storage device) or a combination of multiple devices that are operatively connected or networked together. The activity aggregator engine 116 may be implemented in hardware or a suitable combination of hardware and software. In some embodiments, the activity aggregator engine 116 may be a hardware device including processor(s) 302 executing machine readable program instructions for analyzing data received from the stationary computing device 102 and the mobile phone 106. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The processor(s) 302 may include, for example, microprocessors, microcomputers, microcontrollers, digital signal processors, central processing units, state machines, logic circuits, and/or any devices that manipulate signals based on operational instructions. Among other capabilities, the processor(s) 302 may be configured to fetch and execute computer readable instructions in a memory 306 associated with the activity aggregator engine 116 for performing tasks such as signal coding, data processing input/output processing, power control, and/or other functions.

In some embodiments, the activity aggregator engine 116 may include, in whole or in part, a software application working alone or in conjunction with one or more hardware resources. Such software applications may be executed by the processor(s) 302 on different hardware platforms or emulated in a virtual environment. Aspects of the activity aggregator engine 116 may leverage known, related art, or later developed off-the-shelf software. Other embodiments may comprise the activity aggregator engine 116 being integrated or in communication with a mobile switching center, network gateway system, Internet access node, application server, IMS core, service node, or some other communication systems, including any combination thereof. In some embodiments, the activity aggregator engine 116 may be integrated with or implemented as a wearable device including, but not limited to, a fashion accessory (e.g., a wrist band, a ring, etc.), a utility device (a hand-held baton, a pen, an umbrella, a watch, etc.), a body clothing, or any combination thereof.

In some embodiments, the activity aggregator engine 116 may automatically retrieve interactions between the stationary computing device 102 and the mobile phone 106 over the network 204 via the input devices and the sensors 202 respectively. These interactions may include queries, instructions, conversations, or data from the stationary computing device 102 and the mobile phone 106 to the activity aggregator engine 116, and vice versa. The activity aggregator engine 116 may include a variety of known, related art, or later developed interface(s) 304, including software interfaces (e.g., an application programming interface, a graphical user interface, etc.); hardware interfaces (e.g., cable connectors, the keyboard 108, a card reader, a barcode reader, a biometric scanner, an interactive display screen, etc.); or both.

The activity aggregator engine 116 may further include a system memory 306 for storing at least one of (1) files and related audio, video, or textual data including metadata, e.g., data size, data format, creation date, associated tags or labels, related documents, messages, etc.; (2) user profiles, disease profiles, and user-specific health risk profiles; (3) activity pattern data of the user 104 over a predetermined period of time; (4) a log of profiles of network devices and associated communications including instructions, queries, conversations, data, and related metadata; (5) predefined mathematical models or equations and related predetermined labels. The system memory 306 may comprise of any computer-readable medium known in the art, related art, or developed later including, for example, a processor or multiple processors operatively connected together , volatile memory (e.g., RAM), non-volatile memory (e.g., flash, etc.), disk drive, etc., or any combination thereof. The system memory 306 may include one or more databases such as a profile database 308, which may be sub-divided into further databases for storing electronic files and data. The system memory 306 may have one of many database schemas known in the art, related art, or developed later for storing data from the stationary computing device 102 via the activity aggregator engine 116. For example, the profile database 308 may have a relational database schema involving a primary key attribute and one or more secondary attributes. The profile database 308 may include a user profile database 310, a disease profile database 312, and a personalized health risk profile database 314. In some embodiments, the activity aggregator engine 116 may perform one or more operations, but not limited to, reading, writing, indexing, labeling, updating, and modifying the data, and may communicate with various networked computing devices.

In one embodiment, the system memory 306 may include various modules such as a data aggregator module 316, an activity recognition module 318, a visualization module 322, and a feedback module 320. The data aggregator module 316 may be configured to provide a multimodal interface to collect data from the stationary computing device 102 and the associated input devices, and the mobile phone 106 for use by other modules or for being stored in the database 308. In one example, the data aggregator module 316 may be configured to receive operating system (OS) interrupts being generated by the stationary computing device 102 whenever a keystroke is made on the keyboard 108 or the mouse 110 is clicked by the user 104. The data aggregator module 316 may record such interrupts with their respective time stamps. In another example, the data aggregator module 316 may be configured to retrieve a video feed including one or more images using the webcam 112. In yet another example, the data aggregator module 316 may retrieve data from the sensors 202 of the mobile phone 106. For instance, the mobile phone 106 may include an accelerometer sensor configured to determine any change in acceleration of the mobile phone 106 across X, Y, and Z axes. In some embodiments, the data aggregator module 316 may be configured to dynamically control the operation of the mobile phone sensors 202 and the input devices such as the keyboard 108, the mouse 110, and the webcam 112 at predefined time intervals to minimize energy consumption.

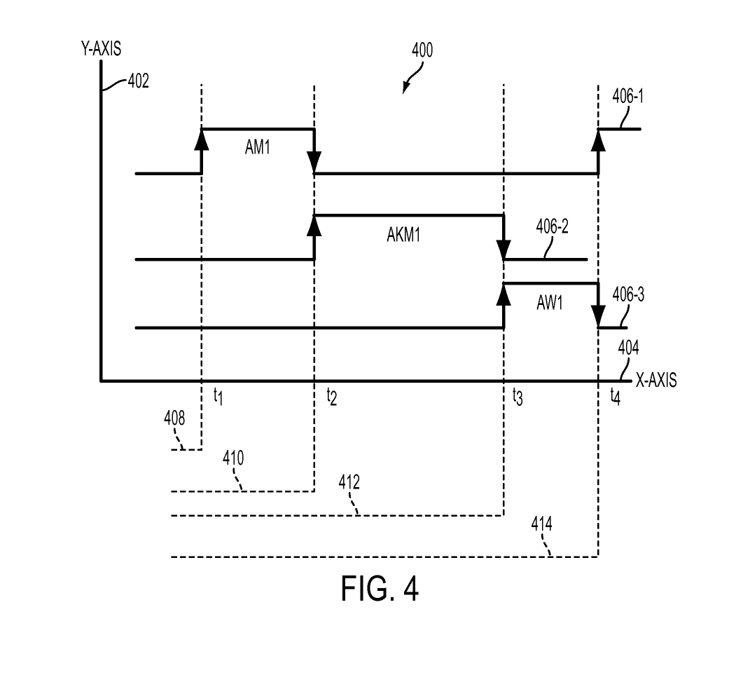

In one embodiment, the data aggregator module 316 may generate control signals in a predetermined timing sequence (FIG. 4). As shown, the timing diagram 400 shows the magnitude of different control signals on Y-axis 402 as a function of time plotted on X-axis 404. The timing diagram 400 illustrates a relationship between a mobile control signal 406-1, a keyboard and mouse (KM) control signal 406-2, and a webcam control signal 406-3 (collectively, control signals 406) generated by the data aggregator module 316 and sensing rate during a number of events. The timing diagram 400 may include a first event 408 that corresponds to activation of the mobile phone sensors 202, a second event 410 that corresponds to active sensing of inputs from the keyboard 108 and the mouse 110, a third event 412 that corresponds to active sensing of inputs from the webcam 112, and a fourth event 414 that corresponds to re-activation of the mobile phone sensors 202. The first event 408 may occur between time intervals t₁ and t₂, the second event 410 may occur between time intervals t₂ and t₃, the third event 412 may occur between time intervals t₃ and t₄, and the fourth event 414 may occur at the time t₄.

During operation, the mobile phone sensors 202, the keyboard 108, the mouse 110, and the webcam 112 may be triggered by the data aggregator module 316 to sense respective inputs as discussed above. In one example, the mobile phone sensors 202 may be activated by a processor (not shown) on the mobile phone 106 or the data aggregator module 316 at the time interval t₁ as indicated by a rising edge of a pulse AM1 on the mobile control signal 406-1. The pulse AM1 may remain active until the time interval t₂ at which the second event 410 may be initiated. At the time interval t₂, the mobile phone sensors 202 may be deactivated by the data aggregator module 316 as indicated by the falling edge of the pulse AM1.

The second event 410 may initiate at the time interval t₂ when the keyboard 108 or the mouse 110 is being operated by the user 104. The data aggregator module 316 may be configured to sense inputs such OS-interrupts at each keystroke of the keyboard 108 or click of the mouse 110 as indicated by active pulse AKM1 on the KM control signal 406-2. The pulse AKM1 may remain active for a predetermined time interval from t₂ to t₃. At the time interval t₃, the data aggregator module 316 may stop using the sensing inputs received from the keyboard 108 and the mouse 110 as indicated by the falling edge of the pulse AKM1 when no input is received by the data aggregator module 316 for a predefined time. Therefore, the third event 412 may be triggered by the data aggregator module 316 at t₃ to sense inputs such as the video feed from the webcam 112 as indicated by the rising edge of a pulse AW1 on the webcam control signal 406-3. If the activity aggregator engine 116 determines that the user 104 is in a non-sedentary position based on inputs received during the active pulses AM1 and AKM1, the data aggregator module 316 may stop using the video feed from the webcam 112 as indicated by the falling edge of the pulse AW1 at the time interval t₄. Simultaneously, the data aggregator module 316 may activate the mobile phone sensors 202 as indicated by the rising edge of another active pulse on the mobile control signal 406-1 at time t₄. In some embodiments, the pulse width of the active pulses such as the active pulses AM1, AKM1, and AW1 corresponding to active sensing operation of the data aggregator module 316 may be predefined. Since the mobile phone sensors 202 may be dynamically switched ON and switched OFF by using a predefined sensor activation sequence as discussed above, energy consumption from a mobile phone battery may be significantly reduced.

In some embodiments, the data aggregator module 316 may be additionally configured to receive different types of data to identify the user 104 via the interface(s) 304 or the data aggregator module 316. Examples of the data include, but are not limited to, employment data (e.g., agent name, agent employee ID, designation, tenure, experience, previous organization, supervisor name, supervisor employee ID, etc.), demographic data (for example, gender, race, age, education, accent, income, nationality, ethnicity, area code, zip code, marital status, job status, etc.), psychographic data (e.g., introversion, sociability, aspirations, hobbies, etc.), system access data (e.g., login ID, password, biometric data, etc.). The data aggregator module 316 may additionally receive or retrieve health data (e.g., existing and past medical conditions such as diabetes, hypertension, and heart stroke, existing and past medications, family history of medical conditions, weight, etc., as well as lifestyle data such as exercise schedule, exercise amount, food habits, sports activity duration, and so on), and other relevant data about each user such as the user 104.

The data aggregator module 316 may communicate the data and inputs received from the mobile phone sensors 202, the keyboard 108, the mouse 110, the webcam 112, and directly from the user 104 via the interface(s) 304 to the activity recognition engine 318 or store the inputs and data with timestamps in the user profile database 310. In some embodiments, the data aggregator module 316 may store attributes of various diseases such as symptoms, preventive measures, favorable food and food habits, etc., and their relation with the sedentary positions in the disease profile database 312.

The activity recognition engine 318 may be configured to use the data and the inputs received from the data aggregator module 316 for determining physical activity of the user 104. In a first example, the activity recognition engine 318 may use the sensor data received from the mobile phone 106 to infer the activity of the user 104. Examples of the activity may include, but not limited to, walking, climbing stairs, sitting, running, and so on. In one example, the activity recognition engine 318 may use the length of a vector, based on Equation 1, which may be received as accelerometer sensor data from the mobile phone 106 to detect if the user 104 is walking. The walking steps may be counted by the activity aggregator engine 116 when the length of the vector moves up and down with respect to the moving average.

L=sqrt(X̂2+Ŷ2+Ẑ2) (1)

where:
L=length of a vector
X=acceleration across X-axis
Y=acceleration across Y-axis
Z=acceleration across Z-axis

In a second example, the activity recognition engine 318 may be configured to use the time-stamped OS-interrupts received from the keyboard 108 or the mouse 110, or both for determining whether the user 104 is in a sedentary position. If a steady stream of OS-interrupts is received over a predetermined time interval, the activity recognition engine 318 may determine that the user 104 may be sitting continuously; else the user 104 may not be sitting during that predetermined time interval.

There may be several instances where the user 104 may be present within the vicinity of the stationary computing device 102 but may not be using the device 102. For example, a user 104 may be sitting adjacent to the stationary computing device 102 and engaged in a conversation or activity with another user. So for example, in order to determine presence of the user 104 at the stationary computing device 102 and determine his sedentary or non-sedentary activity during a predefined time interval, the activity recognition engine 318 may analyze a video feed received from the webcam 112. The video stream may be processed with image recognition software using a variety of computer vision algorithms known in the art, related art, or developed later.

If the user 104, or a predetermined region of interest (ROI) of the user 104, is detected in subsequent video feeds, the activity recognition engine 318 may conclude that the user 104 is sitting on or within a predetermined vicinity of the desk. Otherwise, if the user 104 is not detected from the video feed of a predefined duration, the activity recognition engine 318 may determine that the user 104 may not be present within the vicinity of the stationary computing device 102 or may be standing or walking in that time interval or duration. In order to accurately determine whether the user 104 is in a sedentary or a non-sedentary position, the activity recognition engine 318 may be configured to analyze the data received based on triggered-sensing of the mobile phone sensors 202, the keyboard 108, the mouse 110, and the webcam 112 as discussed above in the description of FIG. 4. Such analyses of data based on triggered-sensing may complement infrastructure-based sensing using the keyboard 108, the mouse 110, and the webcam 112 with the mobile phone sensors 202 for minimizing the probability of missing user activities and significantly reduce battery consumption of the mobile phone 106.

In some embodiments, the activity recognition engine 318 may be configured to correlate the user activity data determined over a predefined period of time (i.e., historical user activity pattern data) with user health data. The user activity data may correspond to the sedentary and non-sedentary positions of the user 104. Such correlated activity pattern data may be communicated to other modules by the activity recognition engine 318 for user information.

The data types of the user activity, user health, and user lifestyle features may vary from being numerical, or categorical, to binary in nature. The data received for use or analyses by the activity recognition engine 318 may easily become very high dimensional due to the large number of factors or features being studied. In addition, the data may also have significant number of missing values since all users may not have or input all the types of features. In order to handle such data of mixed data types, the activity recognition engine 318 may employ a variety of known in the art, related art, or developed later machine learning algorithms to transform the input data and use standard classification techniques on the transformed data. In one example, the activity recognition engine 318 may use Bayesian Canonical Correlation Analysis, which is a matrix factorization based technique that can work with both numerical and categorical data and can impute the missing data values during the transformation.

The machine learning algorithms may assist the activity recognition engine 318 to measure the effect of sedentary time such as sitting time and other statistics, as measured by the activity recognition engine 318, on the lifestyle diseases. In some embodiments, the activity recognition engine 318 may combine the correlated activity pattern data based on the effects of sedentary habits with various predefined disease profiles. These machine learning algorithms may also be used to initially bootstrap the activity recognition engine 318 before sufficient correlated activity pattern data is collected for the engine to build a personalized health risk profiles for the user 104. After tracking the activity pattern of the user 104, these personalized health risk profiles may be used to gauge the risk of various diseases for each user. In some embodiments, risk scores may be provided to the user 104 based on predefined risk thresholds defined in the health risk profiles. The health risk profiles of the user 104 may be stored in the personalized risk profiles database.

The feedback module 320 may be configured to provide various audio, visual, or textual indications to the user 104 on the display screen 114 of the stationary computing device 102 or the mobile phone 106 based on predefined criteria. In a first example, the feedback module 320 may provide an indication to the user 104 if the user 104 is determined to be sitting over a predefined period of time. The indication may be specifically predetermined based on the health data and the lifestyle data of the user 104. In a second example, the feedback module 320 may recommend a predefined sedentary time duration based on the user's lifestyle and health data. For instance, this time duration may be relatively shorter for sedentary users than for relatively active users. In some embodiments, the feedback module 320 may recommend a predefined non-sedentary time duration based on the user's lifestyle and health data. In a third example, the activity recognition engine 318 may be synchronized with the user's calendar so that the indications or alerts may be synchronized with the user's daily routine or work schedule.

The visualization module 322 may be configured to provide customizable or editable visualizations of the determined historical activity pattern data and personalized health risk profiles of the user 104. The visualizations may be provided in interactive formats and forms including, but not limited to, bar graphs, pie charts, and bubble chart. The formats may allow the visualizations to be viewed on, exported, mapped, or downloaded to various computing devices known in the art, related art, or developed later.

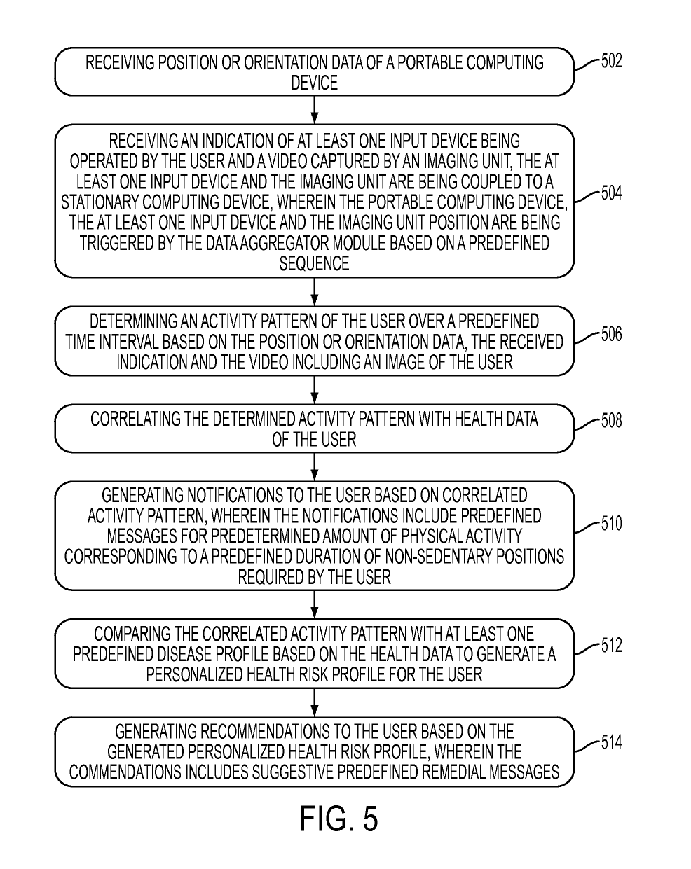

FIG. 5 illustrates an exemplary method 500 for implementing the activity aggregator engine 116, according to an embodiment of the present disclosure. The exemplary method 500 may be described in the general context of computer executable instructions. Generally, computer executable instructions may include routines, programs, objects, components, data structures, procedures, modules, functions, and the like that perform particular functions or implement particular abstract data types. The computer executable instructions may be stored on a computer readable medium, and installed or embedded in an appropriate device for execution.

The order in which the method 500 is described is not intended to be construed as a limitation, and any number of the described method blocks may be combined or otherwise performed in any order to implement the method 500, or an alternate method. Additionally, individual blocks may be deleted from the method 500 without departing from the spirit and scope of the present disclosure described herein. Furthermore, the method 500 may be implemented in any suitable hardware, software, firmware, or combination thereof, that exists in the related art or that is later developed.

The method 500 describes, without limitation, implementation of the exemplary activity aggregator engine 116. One of skill in the art will understand that the method 500 may be modified appropriately for implementation in a various manners without departing from the scope and spirit of the disclosure. The method 500 may be implemented, in at least some embodiments, by the activity recognition engine 318 of the activity aggregator engine 116. For example, the activity recognition engine 318 may be configured using the processor(s) 302 to execute computer instructions to perform various operations.

At step 502, position or orientation data of a portable computing device is received. The portable computing device such as the mobile phone 106 may include a variety of one or more sensors 202 known in the art, related art or developed later for determining its position or orientation. For example, the mobile phone 106 may include an accelerometer sensor, which may determine changes in acceleration of the mobile phone 106 across X, Y, and Z axes. Such changes in the accelerometer sensor data may be used for determining an activity such as walking, climbing stairs, sitting, and so on being performed by a user 104 who is carrying the mobile phone. In another example, the mobile phone 106 may include a GPS sensor capable of providing change in position of the mobile phone 106 that can be indicative of a physical activity being performed by the user 104.

At step 504, an indication of at least one input device being operated by the user 104 and a video of the user 104 captured by an imaging unit are received. A stationary computing device 102 capable of being operated by the user 104 may be associated with an input device such as the keyboard 108 or the mouse 110 or both and an imaging unit such as a webcam 112. The data aggregator module 316 may be configured to receive an indication such as OS—interrupt whenever a keystroke or a click is made on the keyboard 108 and the mouse 110, respectively. The data aggregator module 316 may also receive a video from the webcam 112. The video may include an image of the user 104 operating the stationary computing device 102. Further, the data aggregator module 316 may be configured to trigger the mobile phone sensors 202, the at least one input device, and the imaging unit such as the webcam 112 in a predefined activation sequence for sensing the sensor data, the indication, and the video feed, respectively.

At step 506, an activity pattern data of the user 104 over a predefined time interval is determined based on the position or orientation data, the received indication, and the video including an image of the user 104. The retrieved position or orientation data of the portable computing device such as the mobile phone 106, the indication such as the one or more OS-interrupts of the at least one input device and the video may be analyzed by the activity recognition engine 318 for determining an activity pattern data of the user 104 over a predefined time interval. For example, the activity recognition engine 318 may determine that the user 104 being in a sedentary position such as a sitting position if (1) the position or orientation data is unchanged and (2) the OS-interrupts is received from the input device or the video captured by the imaging unit such as the webcam 112 includes an image of the user 104, or both, in that time interval. Else, the activity recognition engine 318 may determine that the user 104 may be in a non-sedentary position such as a standing position.

At step 508, the determined activity pattern data is correlated with health data of the user. The activity recognition engine 318 may correlate the determined activity pattern data with the health data input by the user 104. Examples of the health data may include, but not limited to, existing and past medical conditions such as diabetes, hypertension, and heart stroke; existing and past medications; family history of medical conditions; weight; lifestyle data such as exercise schedule, exercise amount, food habits, and sports activity duration; and so on. In some embodiments, the correlated activity pattern data may be statistically indicated to the user 104 automatically or upon user request. For example, the correlated activity pattern data may be indicated to the user 104 as textual statistics, or graphically by the visualization module 322, or as a beep by the feedback module 320.

At step 510, notifications are generated to the user 104 based on the correlated activity pattern data. The feedback module 320 may generate notifications or scheduled alerts to the user 104 based on the correlated activity pattern data. The notifications may include predefined messages for predetermined amount of physical activity required by the user 104. In one embodiment, the physical activity may correspond to a predefined duration of non-sedentary positions required by the user 104. Such predefined duration may vary for different users based on their respective activity patterns in view of their health data. The notifications may be generated in audio, video, or textual format, or any combination thereof. In some embodiments, the visualization module 322 may graphically represent the activity pattern data to the user 104 along with the notifications or upon user request.

At step 512, the correlated activity pattern data may be compared with at least one predefined disease profile based on the health data to generate a personalized health risk profile for the user 104. The activity recognition pattern may be further configured to compare the correlated activity pattern data with a disease profile for the user 104. The disease profile may be selected by the activity recognition engine 318 based on the health data of the user. The activity recognition engine 318 may generate a personalized health risk profile for the user 104 based on such comparison. The generated personalized health risk profile may be stored in the database or used by other modules of the activity aggregator engine 116.

At step 514, recommendations are generated to the user 104 based on the generated personalized health risk profile of the user. The feedback module 320 may be configured to automatically, or upon request, generate recommendations including one or more suggestive predefined remedial messages to the user 104 based on the personalized health risk profile specific to that user 104. The remedial messages may suggest various ways to improve a predetermined duration for non-sedentary positions that support to improve health data of the user 104 such as food, food habits, recommended exercise schedule, and so on. In some embodiments, the feedback module 320 may even provide risk scores based on the activity pattern data of the user 104 being beyond a predefined threshold for one or more attributes of a disease or medical condition such as symptoms, acceptable range, etc. in the corresponding predefined disease profile. These risk scores may be automatically, or upon request, provided to the user 104 by the feedback module 320.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

What is claimed is:

1. A computer-implemented method for monitoring a physical activity of a user, the method comprising:
receiving, using a data aggregator module on a processor of a computer, position or orientation data of a portable computing device;
receiving, using the data aggregator module, an indication of at least one input device being operated by the user and a video captured by an imaging unit, the at least one input device and the imaging unit being operationally coupled to a stationary computing device, wherein the portable computing device, the at least one input device and the imaging unit are triggered by the data aggregator module based on a predefined sequence;
determining, using an activity recognition engine on the processor, an activity pattern data of the user over a predefined time interval based on the position or orientation data, the received indication, and the video including an image of the user; and
correlating, using the activity recognition engine, the determined activity pattern data with health data of the user to monitor the physical activity of the user.

2. The method of claim 1, wherein the portable computing device is a mobile phone.

3. The method of claim 1, wherein the imaging unit is a webcam.

4. The method of claim 1, wherein the activity pattern data corresponds to duration of at least one of sedentary positions and non-sedentary positions of the user.

5. The method of claim 1, wherein the health data includes at least one of existing or past medical conditions, family history of medical conditions, weight, exercise schedule, and food habits.

6. The method of claim 1, wherein the position or orientation data is being received from at least one of an accelerometer sensor and a global positioning system (GPS) sensor disposed on the portable computing device.

7. The method of claim 1, wherein the indication is an operating system (OS) interrupt generated by the processor.

8. The method of claim 1, further comprising:
generating control signals, using the data aggregator module, for triggering sensing from at least one of the portable computing device, the at least one input device, and the imaging unit, wherein one or more sensors on the portable computing device are deactivated while at least one of the at least one input device and the imaging unit are being sensed.

9. The method of claim 1, further comprising:
generating, using a feedback module on the processor, notifications to the user based on correlated activity pattern data, wherein the notifications include at least one of an audio indication, a visual indication, or predefined messages for predetermined amount of physical activity corresponding to a predefined duration of non-sedentary positions required by the user.

10. The method of claim 9, wherein the notifications are generated in real time.

11. The method of claim 1, further comprising:
comparing, using the activity recognition engine, the correlated activity pattern data with at least one predefined disease profile based on the health data to generate a personalized health risk profile for the user; and
generating, using the feedback module, recommendations to the user based on the generated personalized health risk profile, wherein the recommendations include suggestive predefined remedial messages.

12. A system for monitoring a physical activity of a user, the system comprising:
a portable computing device including at least one sensor configured to determine a position or an orientation data of the portable computing device;
a stationary computing device including at least one input device and operationally coupled to an imaging unit, the stationary computing device being configured to:
determine a position or an orientation of the portable computing device in communication with the at least one sensor;
receive an indication of the at least one input device being operated by a user;
capture a video including one or more images using the imaging unit; and
an activity aggregator engine in communication with the stationary computing device and the portable computing device, wherein the activity aggregator engine is configured to:
determine an activity pattern data of the user over a predefined duration based on the determined position or orientation, received indication, and the captured video indicating the user; and
correlate the determined activity pattern data with health data of the user to monitor the physical activity of the user.

13. The system of claim 11, wherein the portable computing device is a mobile phone.

14. The system of claim 11, wherein the imaging unit is a webcam.

15. The system of claim 11, wherein the activity pattern data corresponds to duration of at least one of sedentary positions and non-sedentary positions of the user.

16. The system of claim 11, wherein the health data includes at least one of existing or past medical conditions, family history of medical conditions, weight, exercise schedule, and food habits.

17. The system of claim 11, wherein the at least one sensor is a least one an accelerometer sensor and a global positioning system (GPS) sensor.

18. The system of claim 11, wherein the indication is an operating system (OS) interrupt.

19. The system of claim 11, wherein the activity aggregator engine is further configured to generate control signals for triggering sensing from at least one of the at least one sensor, the at least one input device, and the imaging unit, wherein the at least one sensor is deactivated while at least one of the at least one input device and the imaging unit is being sensed.

20. The system of claim 11, wherein the activity aggregator module is further configured to generate notifications to the user based on the correlated activity pattern data, wherein the notifications include at least one of an audio indication, a visual indication, or predefined messages for predetermined amount of physical activity corresponding to a predefined duration of non-sedentary positions required by the user.

21. The system of claim 20, wherein the notifications are generated in real time.

22. The system of claim 11, wherein the activity aggregator engine is further configured to:
compare the correlated activity pattern data with at least one predefined disease profile based on the health data to generate a personalized health risk profile for the user; and
generate recommendations to the user based on the generated personalized health risk profile, wherein the recommendations include suggestive predefined remedial messages.
